(19) United States
(12) Patent Application Publication
(10) Pub. No.: US 2007/0250856 A1
(43) Pub. Date: Oct. 25, 2007

(54) Distinguishing National and Local Broadcast Advertising and Other Content

(76) Inventors: Jennifer Leavens, Sherman Oaks, CA (US); Joshua Smallman, Villa Park, CA (US); Nicholas Seet, Los Angeles, CA (US)

Correspondence Address: FENWICK & WEST LLP, SILICON VALLEY CENTER, 801 CALIFORNIA STREET, MOUNTAIN VIEW, CA, 94041, US

(21) Appl. No.: 11/695,596

(22) Filed: Apr. 2, 2007

Related U.S. Application Data
(60) Provisional application No. 60/744,134, filed on Apr. 2, 2006.

(51) Int. Cl. H04N 7/025; H04N 7/10

(52) U.S. Cl. 725/36; 725/32

(57) ABSTRACT

Media broadcasts associated with different local markets can contain both nationally and locally broadcast content. To determine whether particular media items in the broadcasts are broadcast nationally or locally, the media items are identified and their time of occurrence is determined. The media items can then be classified as nationally or locally broadcast based, at least in part, on whether the occurrences of the media items in the different media broadcasts correspond in time, within a threshold.

### CROSS REFERENCE TO RELATED APPLICATIONS

This application claims the benefit of U.S. Provisional Application No. 60/744,134, filed Apr. 2, 2006, which is incorporated by reference in its entirety.

### BACKGROUND

This invention relates generally to systems and methods for distinguishing nationally broadcast content from locally broadcast content, such as advertisements.

Advertisers purchase advertisements from broadcasters with the assumption that the advertisements have been or will be aired. However, significant discrepancies have been found between what is purchased and what is actually aired. To address this problem, both manual and automatic monitoring systems have been developed to determine whether and when particular advertisements have been aired, thus enabling the auditing of those broadcasts. One type of automatic monitoring system uses electronic fingerprinting and database matching technology to detect whether certain advertisements have been aired in one or more broadcasts. These monitoring systems provide a useful reality check and a high level of transparency for the advertiser as well as the broadcaster.

In addition to confirming whether a particular advertisement has been played as intended in a given broadcast, there may be a business need to determine whether a particular advertisement was broadcast nationally or locally. This is because advertisers often separate their national and local advertising budgets. As a result, the detections of nationally aired advertisements must be correctly attributed to the national schedule so they can be accurately credited to the national budget, and the same must be done for locally aired advertisements and the local budget. This requires identification and distinguishing of a national advertisement (i.e., one that was syndicated or broadcast nationally) from a local advertisement (i.e., one that was broadcast locally).

Although advertisers may choose to broadcast advertisements with different audio content for the nationally purchased schedules and the locally purchased schedules, they often choose to air the exact same advertisement for both schedules. As a result, an advertisement purchased from a national network will sound identical to an advertisement purchased from a local station. In such a case, an auditing system that uses audio fingerprinting technology cannot differentiate between the two advertisements because audio fingerprinting relies on the audio patterns of an individual advertisement or program to be identified. If the audio of an advertisement or program from a national network is identical to that of the audio of an advertisement or program from a local station or other local entity, the audio fingerprinting technology will not be able to differentiate the two advertisements or programs using only the content of the audio. Therefore, a challenge for an audio identification or audio fingerprinting company is differentiating an airing of a locally purchased advertisement or program from an airing of a nationally purchased advertisement or program.

Complicating the problem, local advertisements may be found in national broadcasts. To broadcast a program nationally, broadcast networks may have their affiliate stations all play the same program in the form of a network, or they may syndicate their program content nationally. Included within the national program may be set of national advertisements, which each station is obligated to play in exchange for the program, as well as room within the program for the station to insert local advertisements. Accordingly, even when monitoring a nationally broadcast program, an audio fingerprinting system by itself has no way of disambiguating between a national and a local advertisement in the nationally broadcast program.

The problem of distinguishing content that is broadcast nationally from content that is broadcast locally is not limited to auditing advertisements. In addition to advertisements, it may be desirable to distinguish whether other types of content are local or national. For example, songs and other copyrighted content may be aired in both national and local broadcasts, whether in radio, television, or some other type of broadcast. As license fees for use of the content may vary depending on its use, it may be desirable to determine whether the content was broadcast nationally or locally. As explained above, an identification system, by itself, would not be able to make this determination.

Accordingly, there exists a need for technology that can determine whether content in a broadcast was broadcast nationally or locally, where the content can be an advertisement, a protected work, or any other type of media item that can be identified electronically.

### SUMMARY

To distinguish between nationally broadcast and locally broadcast content, embodiments of the invention apply assumptions about when and where that content is aired in multiple broadcast markets. In particular, a nationally broadcast media item will generally occur at the same time in the broadcasts associated with different local market, whereas a locally broadcast media item typically will not.

In one embodiment, media items (such as advertisements) are integrated into programs that are broadcast nationally. Some of the media items are integrated into the programs by the national network, so these national media items appear in the broadcast for each local market. Other media items are added at the local level, without coordination among the local markets, so these local media items typically vary for the different local broadcasts. Accordingly, whether a particular media item in a particular broadcast is national or local may be determined, at least in part, on whether the media item has corresponding media items at the same position in other broadcasts from different local markets.

In one embodiment, a system determines whether occurrences of a particular set of media items in a broadcast are national or local. This set of media items to be monitored may include advertisements, non-advertising content, or any other type of media content that could occur in either local or national broadcasts. The system receives a plurality of broadcasts that are associated with local markets, which broadcasts may be television, radio, or any other type of broadcast. The broadcasts include nationally-aired segments, such as television or radio shows. Occurrences of the media items in the nationally-aired segments of the broadcasts are identified, and the position of these occurrences in each of the nationally-aired segments is determined. The system declares one or more of the occurrences of the media items to be nationally broadcast based at least in part on whether the occurrences of the media items in the broadcasts have the same position within a threshold in the same nationally-aired segments.

### BRIEF DESCRIPTION OF THE DRAWINGS

FIG. 1 is a diagram of an advertising disambiguation system for distinguishing national media items from local media items, where the media items are advertisements, in accordance with an embodiment of the invention.

FIG. 2 is a flow diagram of a method for distinguishing national media items from local media items, in accordance with an embodiment of the invention.

FIG. 3 is a table showing the occurrences of an advertisement identified within broadcasts from different markets, the information in the table for use in classifying the occurrences of the advertisement as local or national, in accordance with an embodiment of the invention.

The figures depict various embodiments of the present invention for purposes of illustration only. One skilled in the art will readily recognize from the following discussion that alternative embodiments of the structures and methods illustrated herein may be employed without departing from the principles of the invention described herein.

### DETAILED DESCRIPTION

Embodiments of the invention distinguish a media item broadcast from a local station from a media item broadcast from a national network even when there is no distinguishable difference in the content of the media item when it is broadcast locally or nationally. The broadcasts may be television broadcasts (including traditional, cable, and satellite), radio broadcasts (including traditional and satellite), or any other type of broadcast that can have national and local content. In various embodiments described below, advertisements are the particular type of media items that are classified. However, many other types of media items can be classified using embodiments of the invention, including non-advertising content, songs, copyrighted works, and any other content that can be broadcast at the national and the local level. As used herein, the term media includes any audio and/or video content in any format, including without limitation radio, television, cable, satellite, and Internet streams.

Media is often delivered to large audiences as a broadcast. Due to the size of the national audience and its varying tastes and demand for content, the national audience is commonly divided into a number of local markets, which typically correspond to different geographical regions. Media content can be broadcast locally to just one or a small subset of the local markets, or it can be broadcast via a national network to most or all of the local markets. As used herein, national and local broadcasts need not be limited to any particular national boundary or geographical region, and they may include international regions. The terms local and national simply refer to a relationship in which a “national” network includes a plurality of “local” broadcasters that serve local markets. Content that is broadcast nationally is integrated and provided via the national network to all or most of the local broadcasters, whereas content that is broadcast locally is integrated at a local broadcaster.

For example, advertisements can be integrated at the national level or at the local level. A national advertisement can be purchased from a national network. National networks distribute their signals to the entire nation through a network of broadcast affiliates or cable and satellite head-ends. Alternatively, a local advertisement can be purchased from local entities, and the local advertisements will not air nationally, but only on the signal owned or controlled by that local entity.

Media broadcasts commonly include segments or programs. For example, television broadcasts typically comprise a number of prescheduled television shows, and radio broadcasts typically comprise a number of prescheduled radio shows. Advertisements are usually integrated into these shows. A national program is a program that has been created and syndicated by a national broadcast network. A local program may be a program that is placed by a local television or radio station, oftentimes a local news show or a rerun of a program previously purchased by the station. Because the national program is distributed nationally via a number of different local broadcast affiliates, there is an opportunity to customize the content for the different local markets. A common example is how national programs integrate advertisements while also including space in the programs where local broadcasters can integrate their own advertisements. Accordingly, an advertisement in a nationally-aired program may be a national advertisement or a local advertisement.

To disambiguate between national and local advertisements (or other media items), a techniques involves detecting the occurrences of particular advertisements in different broadcasts and then comparing the air times of the advertisements against each other. National advertisements can be differentiated from local advertisements by using assumptions about how national networks integrate advertisements into their programming. This allows an advertising recognition system to match national advertisement detections to a national advertisement schedule without accidentally matching local detections to the national schedule, and vice versa.

One assumption is based on the observations that national networks control when and where nationally purchased advertisements air within their programs. For example, if an advertisement for a program is purchased from a national network, that national network will determine the point within the program that this advertisement will air. The advertisement will thus air in the same position (i.e., the same minute after the start of the show) in every local market in which the program airs. For example, if the national advertisement airs 15 minutes after the start of the show in one market, it will air 15 minutes after the start of the show in every market.

Moreover, even if a particular market airs a national program at a different start time than another market, the national advertisement will still run at the same point within the program in each market. For example, if a television show starts at 8 p.m. in New York but 7 p.m. in Chicago, the positions of the national advertisements within the show will remain the same, even if the airtime is one hour different. For example, if the national advertisement airs at 8:15 p.m. in New York, it will air at 7:15 p.m. in Chicago.

Another assumption recognizes the variance in the scheduling for certain types of broadcasts. For example, there may be a window of approximate five to seven minutes where advertisements can be designated as national but not match up exactly. This window is apparent with several market comparisons. If an advertisement in a program airs at 8:15 p.m. in New York, 7:14 p.m. in Chicago, 8:13 p.m. in Los Angeles, 8:16 p.m. in Atlanta, and 7:17 p.m. in Denver, the advertisement is probably a national advertisement even though it did not occur at the exact same time in each local market.

These assumptions are simply a set of heuristics for determining whether advertisements within nationally-aired programs are national or local advertisements. In other contexts, such as detecting licensed music content in television, radio, or Internet broadcasts, different assumptions may be used, either instead of or in additional to the ones described herein.

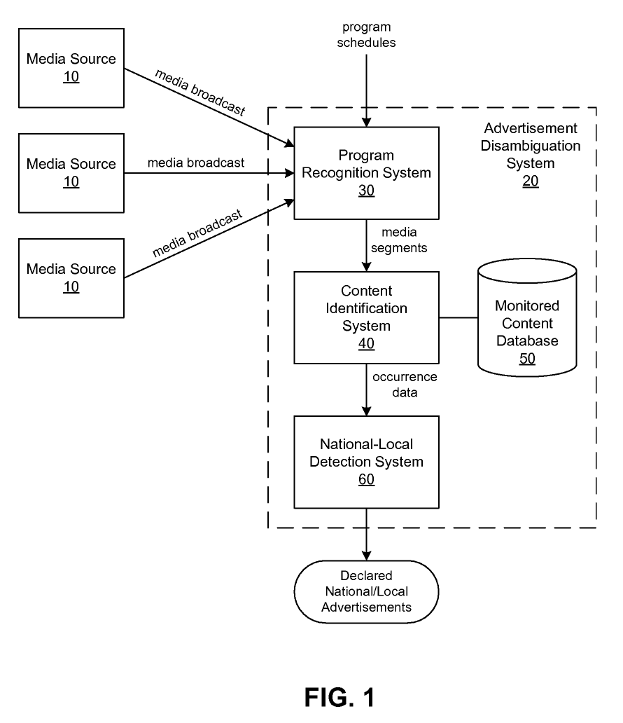

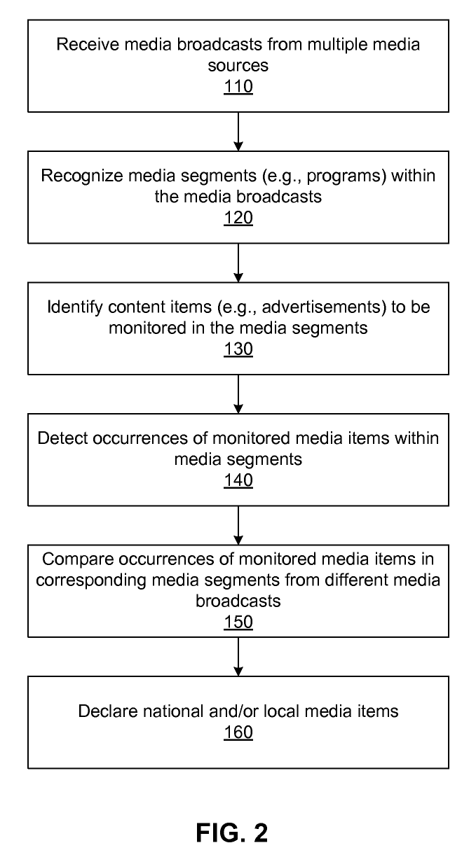

FIG. 1 illustrates an advertising disambiguation system for distinguishing local and national advertisements that are integrated into programs and broadcast via multiple media sources associated with different local markets. FIG. 2 illustrates a process for using the system of FIG. 1 in accordance with one embodiment.

As FIG. 1 illustrates, the advertisement disambiguation system 20 is configured to receive 110 media broadcasts from multiple media sources 10, each of which may be associated with a local market for the distribution of the media. The advertisement disambiguation system 20 comprises a program recognition system 30, a content identification system 40, a monitored content database 50, and a national-local detection system 60. The advertisement disambiguation system 20 may be implemented as multiple disparate systems, geographically distant or in a single location, or it may be implemented in a single computing system.

In operation, in one embodiment, the advertisement disambiguation system 20 receives 110 media broadcasts from the media sources 10. Each media broadcast may represent a broadcast from a particular local market. A media segment (i.e., a television or radio program) is recognized 120 in the received media broadcasts by the program recognition system 30. In one embodiment, the program recognition system 30 receives program schedule information that allow it to identify particular segments in the media broadcasts, based, for example, on the time location in the broadcasts. Alternatively, or in addition, the program recognition system 30 may use program ID information or a content recognition algorithm to recognize particular programs. A program ID is an index used to locate information about the airing of a program within a database of programming information. The program ID can thus be used to align segments of the media broadcasts.

For each of one or more particular media segments, the content identification system 40 analyzes the content to detect 140 occurrences of any of a set of target advertisements that are being monitored. The advertisement disambiguation system 20 may store a list of advertisements, or otherwise identify 130 information about the monitored advertisements, that are to be monitored across a variety of stations. The monitored advertisements may be received from a remote source and/or may be stored within the system 20 in a monitored content database 50.

The content identification system 40 may use a variety of techniques to detect 140 occurrences of an advertisement in the media segments. In one embodiment, the identification of the advertisements in the segments is performed by extracting characteristic electronic fingerprints from the media broadcast. The advertisements from which the fingerprints are extracted can then be matched against a database of known fingerprints, thereby allowing identification of the advertisement. Technology for generating fingerprints and identifying content based thereon is described in U.S. application Ser. No. 10/132,091, filed Apr. 24, 2002; U.S. application Ser. No. 10/830,962, filed Apr. 22, 2004; and U.S. application Ser. No. 11/219,385, filed Sep. 1, 2005; each of which are incorporated by reference in its entirety.

These resulting list of detections may comprise a mix of nationally purchased advertisements and locally purchased advertisements. To differentiate the national and local advertisements, the national-local detection system 60 separates out the advertisements that aired in national programs from those that aired on local programs. A national program airs in most markets across the nation over a system of station affiliates or cable/satellite head-ends. A national program generally airs in all four time-zones at approximately the same time (as corrected for time-zones), with national advertisements occurring within these programs at approximately the same time from the beginning of the program. Local programs air only on local stations and/or cable head-ends. Typically, national advertisements will air only in national programs (e.g., distributed by a network or a national syndicator); however, local advertisements can air in national programs or in local programs.

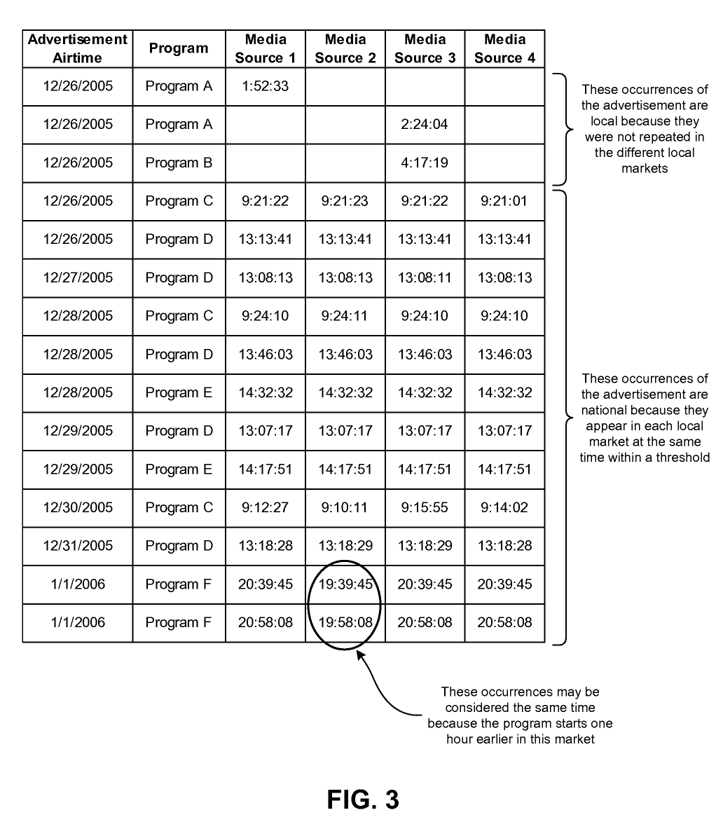

The data describing the occurrences of advertisements that aired in national programs are therefore analyzed by the national-local detection system 60. In one embodiment, advertisements that aired in different markets but in like-programs are divided out, and the start times are lined up. For example, if a particular program starts at 8 p.m. in one local market, but 7 p.m. in another local market, the start times are lined up and assumed to be the same for this analysis. An example of a list of occurrences of a particular advertisement in a set of nationally-aired programs is shown in FIG. 3.

The detection times for the occurrences can then be compared by the national-local detection system 60. If the occurrences of a particular advertisement are at the same “position” in a particular national program in all or most markets, within a threshold or tolerance, the national-local detection system 60 declares these advertisements to be a national advertisement. Instances where detections air on one or a few stations at a particular position, but not in most markets are determined to be local advertisements, and the advertisements may be declared as such. In one embodiment, declaring an advertisement to be national or local comprises reporting that determination to a user as an observable output or marking the advertisement in a database as being a national advertisement.

The principles described herein may be applied in various applications. Examples of various embodiments include but are not limited to differentiating national promotional spots, differentiating regional advertisements, differentiating television syndication ads, and differentiating radio syndication ads. In another embodiment, the system can be used to differentiate any cross time-zone patterns from signals that do not repeat in the same positions across time-zones.

Embodiments of the invention may also be used to differentiate content between local broadcasts and “unwired national networks.” Unwired networks are a kind of virtual network, where a middle-man obtains local advertising spots from various local stations and then packages the advertisements together to sell a national-type advertisement. For example, one might buy from an unwired network if the goal was to purchase a lot of local stations, nationwide, or almost nationwide, and doing so from a national budget or as “one-stop shopping.” For example, an advertiser could buy an advertisement from an unwired network to be aired at a certain time in the morning. This might be preferable to buying a national advertisement in a nationally-aired morning program if it is the case that in some markets the highest rated morning show is a local show for which advertisements cannot be purchased nationally. Because the unwired network purchases local advertisements on behalf of the advertisement buyer, and those advertisements may be purchased at any time on any station during any program, it may not be possible to differentiate an advertisement bought via an unwired network or bought locally. However, embodiments of the invention may be used to differentiate advertisements on “unwired national networks” from those purchased nationally.

In one embodiment, the system identifies discrepant sources, such as a “sped-up” content or other alterations to the original media broadcast that would cause a national media item in the broadcast to line up with corresponding media items in other broadcasts. It can be appreciated that such discrepant sources might lead to false negatives, in which a nationally broadcast media item is marked as a local item. Where it has been determined that a discrepant media source is altering the content in the media broadcast, the system may identify that the content has been modified so that the discrepant source can be flagged. This allows the system to disregard or otherwise account for the discrepancy when analyzing media items in the media broadcast from the discrepant sources.

### SUMMARY

The foregoing description of the embodiments of the invention has been presented for the purpose of illustration; it is not intended to be exhaustive or to limit the invention to the precise forms disclosed. Persons skilled in the relevant art can appreciate that many modifications and variations are possible in light of the above teachings.

Some portions of above description describe the embodiments of the invention in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

In addition, the terms used to describe various quantities, data values, and computations are understood to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or the like, refer to the action and processes of a computer system or similar electronic computing device, which manipulates and transforms data represented as physical (electronic) quantities within the computer system memories or registers or other such information storage, transmission, or display devices.

Embodiments of the invention may also relate to an apparatus for performing the operations herein. This apparatus may be specially constructed for the required purposes, or it may comprise a general-purpose computing device selectively activated or reconfigured by a computer program stored in the computer. Such a computer program may be stored in a computer readable storage medium, such as, but not limited to, any type of disk including floppy disks, optical disks, CD-ROMs, magnetic-optical disks, read-only memories (ROMs), random access memories (RAMs), EPROMs, EEPROMs, magnetic or optical cards, application specific integrated circuits (ASICs), or any type of media suitable for storing electronic instructions, and each coupled to a computer system bus. Furthermore, the computers referred to in the specification may include a single processor or may be architectures employing multiple processor designs for increased computing capability.

Embodiments of the invention may also relate to a computer data signal embodied in a carrier wave, where the computer data signal includes any embodiment of a computer program product or other data combination described herein. The computer data signal is a product that is presented in a tangible medium and modulated or otherwise encoded in a carrier wave transmitted according to any suitable transmission method.

The algorithms and displays presented herein are not inherently related to any particular computer or other apparatus. Various general-purpose systems may also be used with programs in accordance with the teachings herein, or it may prove convenient to construct more specialized apparatus to perform the required method steps. The required structure for a variety of these systems will appear from the description above. In addition, embodiments of the invention are not described with reference to any particular programming language. It is appreciated that a variety of programming languages may be used to implement various embodiments of the invention as described herein, and any references to specific languages are provided for disclosure of enablement and best mode of embodiments of the invention.

Finally, it should be noted that the language used in the specification has been principally selected for readability and instructional purposes, and it may not have been selected to delineate or circumscribe the inventive subject matter. Accordingly, the disclosure of the embodiments of the invention is intended to be illustrative, but not limiting, of the scope of the invention, which is set forth in the following claims.

What is claimed is:

1. A method for distinguishing between locally and nationally broadcast content, the method comprising:
storing information for a set of media items to be monitored;
receiving a plurality of broadcasts that include one or more nationally-aired segments, the broadcasts associated with local markets;
identifying one or more occurrences of the media items in the nationally-aired segments of the broadcasts;
determining a position in the nationally-aired segments of the occurrences of the media items; and
declaring one or more of the occurrences of the media items to be nationally broadcast based at least in part on whether the occurrences of the media items in the broadcasts have the same position within a threshold in the same nationally-aired segments.

2. The method of claim 1, further comprising:
declaring one or more of the occurrences of the media items to be locally broadcast based at least in part on whether the occurrences of the media items in the broadcasts do not have the same position within a threshold in the same nationally-aired segments.

3. The method of claim 1, wherein the media items comprise an advertisement.

4. The method of claim 1, wherein the media items comprise non-advertising content.

5. The method of claim 1, wherein the broadcasts are television broadcasts.

6. The method of claim 5, wherein the segments of the broadcasts are television shows.

7. The method of claim 1, wherein the broadcasts are radio broadcasts.

8. The method of claim 1, wherein identifying occurrences of media items in the nationally-aired segments of the broadcasts comprises:
generating an electronic fingerprint of each of the media item; and
matching the electronic fingerprints against a database of electronic fingerprints of known media items.

9. The method of claim 1, further comprising:
identifying the nationally-aired segments in the broadcasts using program schedule information.

10. The method of claim 1, further comprising:
identifying the nationally-aired segments in the broadcasts using program ID information.

11. The method of claim 1, wherein each of the broadcasts correspond to local markets associated with geographic regions.

12. The method of claim 1, further comprising:
identifying one or more broadcasts as being from discrepant media sources, wherein content within the broadcast is altered to change time positions of content within the broadcast; and
disregarding the discrepant media sources during the declaring step.

13. The method of claim 1, wherein the threshold is 5 minutes.

14. The method of claim 1, wherein the threshold is 5 minutes.

15. The method of claim 1, wherein the occurrences of the media items are declared to be nationally broadcast if the occurrences of the media items in at least two broadcasts have the same position within a threshold in the same nationally-aired segments.

16. The method of claim 1, wherein the occurrences of the media items are declared to be nationally broadcast if the occurrences of the media items in a majority of the broadcasts have the same position within a threshold in the same nationally-aired segments.

17. The method of claim 1, wherein the occurrences of the media items are declared to be nationally broadcast if the occurrences of the media items in all of the broadcasts have the same position within a threshold in the same nationally-aired segments.

18. A method for distinguishing between locally and nationally broadcast content, the method comprising:
receiving a first media broadcast associated with a first local market;
receiving a second media broadcast associated with a second local market, the second local market different from the first local market;
identifying an media item in a first segment of the first broadcast;
identifying the media item in a second segment of the second broadcast;
determining a time position of the media item within each of the first and second segments; and
declaring the media item to be a national media item if the difference between the time positions of the media item within the first and second segments are within a threshold.

19. The method of claim 18, wherein the first and second media items comprise an advertisement.

20. The method of claim 18, wherein the first and second media broadcasts are each selected from a group consisting of: television broadcasts and radio broadcasts.

21. The method of claim 18, wherein identifying the media item in the first segment and identifying the media item in the second segment each comprises:
generating an electronic fingerprint of the media item; and
matching the electronic fingerprint against a database of electronic fingerprints of known media items.

22. The method of claim 18, further comprising:
identifying the first and second segments in the first and second media broadcasts using at least one of program schedule information and program ID information.

23. The method of claim 18, wherein the threshold is a value between 5 and 7 minutes, inclusive.

24. A method for distinguishing between locally and nationally broadcast content, the method comprising:
receiving a media broadcast from each of a plurality of different local markets;
identifying media items within the media broadcasts;
logging times in which media items occurred in the media broadcasts;
determining whether the identified media items are nationally broadcast or locally broadcast, at least in part, by comparing the logged times of media items that contain the same content; and
marking the media items as local or national based on the determining.

25. The method of claim 24, wherein the media items comprise an advertisement.

26. The method of claim 24, wherein the media broadcasts are each selected from a group consisting of: television broadcasts and radio broadcasts.

27. The method of claim 24, wherein identifying the media items within the media broadcasts comprises:
generating an electronic fingerprint of each of the media items; and
matching the electronic fingerprints against a database of electronic fingerprints of known media items.

28. The method of claim 24, further comprising:
identifying one or more broadcasts as being from discrepant media sources, wherein content within the broadcast is altered to change time positions of content within the broadcast; and
disregarding the discrepant media sources during the determining step.

29. The method of claim 24, wherein the determining comprises determining that the media items are nationally broadcast if at least two of the logged times for at least two of the media items that contain the same content are within a threshold.

30. The method of claim 24, wherein the determining comprises determining that the media items are nationally broadcast if a majority of the logged times for at least two of the media items that contain the same content are within a threshold.

31. The method of claim 24, wherein the determining comprises determining that the media items are nationally broadcast if all of the logged times for at least two of the media items that contain the same content are within a threshold.
